(19) United States
(12) Patent Application Publication
(10) Pub. No.: US 2012/0307621 A1
(43) Pub. Date: Dec. 6, 2012

(54) SYSTEM, APPARATUS, AND METHOD FOR REDUCING RECOVERY FAILURE DELAY IN WIRELESS COMMUNICATION SYSTEMS

(75) Inventors: FAHED I. ZAWAIDEH, San Diego, CA (US); MURALI B. BHARADWAJ, San Diego, CA (US)

(73) Assignee: QUALCOMM INCORPORATED, San Diego, CA (US)

(21) Appl. No.: 13/487,089

(22) Filed: Jun. 1, 2012

Related U.S. Application Data
(60) Provisional application No. 61/492,735, filed on Jun. 2, 2011.

(51) Int. Cl. H04W 76/00

(52) U.S. Cl. 370/216

(57) ABSTRACT

A method, an apparatus, and a computer program product for wireless communication are provided in which blocking of LTE access due to Internet Protocol Multimedia Subsystem (IMS) Packet Data Network (PDN) recovery failure is prevented. The blocking may be caused by detach and immediate attach to LTE because of internal or other commonly executed network procedures. Recovery procedures may be modified to avoid prolong periods when access to the PDN is prevented based on long backoff delays set by an operator for PDN failure conditions. Based on a reason for failure to reconnect, a backoff period may be selected from an operator define minimum backoff time and a locally configured minimum backoff time.

### CROSS-REFERENCE TO RELATED APPLICATION(S)

This application claims the benefit of U.S. Provisional Application Ser. No. 61/492,735, entitled “System, Apparatus, And Method For Reducing Recovery Failure Delay In Wireless Communication Systems” and filed on Jun. 2, 2011, which is expressly incorporated by reference herein in its entirety.

### BACKGROUND

1. Field

The present disclosure relates generally to communication systems, and more particularly, to reducing recovery failure delay in wireless communication systems.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, techniques are described that prevent blocking of LTE access due to Internet Protocol Multimedia Subsystem (IMS) Packet Data Network (PDN) recovery failure caused by detach and immediate attach to LTE because of internal or other commonly executed network procedures. Recovery procedures may be modified to avoid prolong periods when access to the PDN is prevented based on long backoff delays set by an operator for PDN failure conditions.

In an aspect of the disclosure, a notification of disconnection is received from a PDN. An attempt to reconnect to the PDN may fail and a reason for the failure may be determined Based on the determined reason, a backoff period may be selected, where the backoff period is used to block access until an attempt to reconnect to the PDN is made. The backoff period is selected based on the reason for the failure to reconnect.

In an aspect of the disclosure, the selected backoff time comprises one of a minimum backoff time defined by a network operator for activating the packet data network after reconnect failures, and a locally configured minimum backoff time that is less than the minimum backoff time defined by the network operator. The selected backoff time comprises the locally configured minimum backoff time when the notification of disconnection is received after performing a procedure that includes detaching from the packet data network. The procedure may comprise a universal subscriber identity module refresh procedure or a code division multiple access subscriber identity module refresh procedure. The notification of disconnection may be received from the packet data network. The selected backoff time may comprise the minimum backoff time defined by the network operator when the failure to reconnect occurs as a result of a failure of the packet data network.

In an aspect of the disclosure, reconnection to the packet data network is attempted by performing a packet data network detach, and subsequently performing a packet data network attach immediately after detaching from the packet data network.

In an aspect of the disclosure, determining the reason for the failure to reconnect includes identifying a reason code generated during the attempt to reconnect to the packet data network.

In an aspect of the disclosure, a reset is performed which triggers a detach from the packet data network followed by an immediate attach to the packet data network.

In an aspect of the disclosure, the packet data network comprises a Long Term Evolution (LTE) network or an evolved High Rate Packet Data (eHRPD) network.

In an aspect of the disclosure, the duration of the minimum backoff time defined by the network operator is 1 minute or more, and wherein the locally configured minimum backoff time is greater than or equal to 0 seconds.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows a diagram illustrating a wireless communication network, in accordance with aspects of the disclosure.

FIG. 2 shows a diagram illustrating an access network, in accordance with aspects of the disclosure.

FIG. 3 shows a diagram illustrating a hardware implementation for an apparatus employing a processing system, in accordance with aspects of the disclosure.

FIG. 4 shows a diagram illustrating a multiple access communication system, in accordance with aspects of the disclosure.

FIG. 5A shows a diagram illustrating an example of a frame structure for use in an access network, in accordance with aspects of the disclosure.

FIG. 5B shows a format for an uplink (UL) in a Long Term Evolution (LTE) network, in accordance with aspects of the disclosure.

FIG. 5C shows a diagram illustrating a radio protocol architecture for the user and control plane, in accordance with aspects of the disclosure.

FIG. 6 is a diagram illustrating an example of an evolved Node B and user equipment in an access network.

FIGS. 7 and 8 show diagrams illustrating various process flows to reduce recovery failure delay in a communication network, in accordance with aspects of the disclosure.

FIG. 9 is a diagram illustrating an embodiment of functionality of an apparatus configured to facilitate wireless communication, in accordance with aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented utilizing electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The techniques described herein may be utilized for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often utilized interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA, which employs OFDMA on the downlink and SC-FDMA on the uplink. UTRA, E-UTRA, GSM, UMTS, and LTE are described in documents from 3GPP. CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long- range, wireless communication techniques. For clarity, certain aspects of the techniques are described below for LTE, and LTE terminology is utilized in much of the description below.

Aspects of the disclosure provide techniques to prevent blocking of LTE access due to IMS PDN recovery failure caused by detach and immediate attach to LTE scenarios, wherein for example, LTE detach and/or attach may occur following Universal Subscriber Identity Module (USIM) or CDMA Subscriber Identity Module (CSIM) refresh scenarios. In one example, a carrier may configure a minimum detach time from an LTE Radio Access Network (RAN) when a reattach failure occurs. Recovery may fail because an IMS agent or component of a user equipment (UE) attempts recovery too quickly after a USIM or CSIM refresh that causes disconnection from the IMS PDN. USIM and CSIM refresh may occur frequently in an LTE RAN and subsequent reattach failures may result in the UE camping away from the LTE RAN for long periods of time. As a result, high speed service may be degraded.

In certain embodiments, a service provider may establish policies and requirements whereby the IMS framework of a UE attempts to reestablish the PDN connection after the PDN is disconnected or after a PDN failure occurs. If the attempted reconnection fails, then the UE may detach from the RAN (e.g. LTE) for a predefined period of time. The predefined period of time may be defined by the service provider operating the RAN, based on requirements specific to the service provider. The predefined period of time may be implemented using a carrier-specific avoidance timer, which may be configurable for a given network and/or may comprise a nominal value. The carrier specific avoidance timer may be configured by the carrier, and may define a minimum backoff period or delay, such as T PDN Activate Backoff Period, before connection to the RAN can be reattempted.

In the example of an LTE RAN, USIM or CSIM refresh may cause detachment from the PDN. In another example, a Subscriber Identity Module (SIM) application may trigger an immediate detach which causes disconnection of the IMS PDN. An IMS attempt to connect quickly may fail and cause PDN recovery failure logic to be initiated, which may prevent the UE from reattaching to the LTE RAN for the predefined period time. The UE may then camp away from the LTE RAN for a time that can be defined in minutes and which can lie within a range of between 1 and 15 minutes, for example.

In an aspect of the disclosure, if an IMS client or IMS framework of the UE is in registered state and IMS PDN is connected, then IMS may receive PDN disconnect indication from a Data Service (DS) Subsystem of the UE because of USIM refresh (e.g., USIM refresh may cause LTE detach and/or attach immediately). IMS may retry PDN connection, based on PDN recovery logic, by sending the DS Subsystem a PDN connect request. When IMS receives a NO_SRV reason code from the DS Subsystem when receiving PDN connect failure indication, then IMS may retry PDN connect in case LTE has not been reattached after USIM refresh or after a period controlled by a predefined or configurable timer, such as a configurable carrier specific avoidance timer. After a PDN connection is established, IMS may start a new IMS registration by sending a registration packet to IMS core network over the established PDN connection.

In an aspect of the disclosure, USIM and CSIM refresh scenarios may occur frequently in an LTE network, which may cause a UE to camp away from LTE for a long period of time, resulting in reduced performance. Reduced performance may be measurable as a decrease in throughput and/or an apparent loss of high speed service. Accordingly, aspects of the disclosure provide techniques to prevent blocking of LTE due to IMS PDN recovery failure, including recovery failures caused by incidences of detach and subsequent attempts at immediate reattach to LTE following USIM or CSIM refresh.

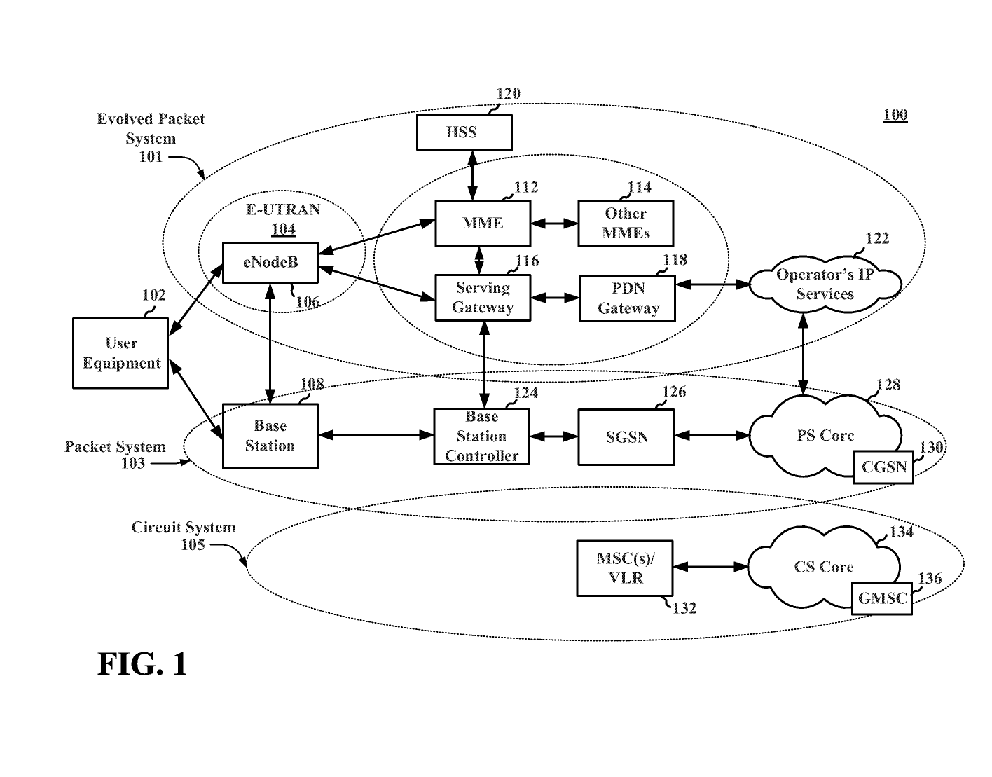

FIG. 1 is a diagram illustrating a wireless network architecture 100 employing various apparatus, in accordance with certain aspects of the disclosure. The network architecture 100 may include an Evolved Packet System (EPS) 101. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS may interconnect with other access networks, such as a packet switched core (PS core) 128, a circuit switched core (CS core) 134, etc. As shown, the EPS provides packet-switched services. However, those skilled in the art will readily appreciate that the various concepts presented throughout this disclosure may be extended to networks providing circuit-switched services, such as the network associated with CS core 134.

The network architecture 100 may further include a packet switched network 103 and a circuit switched network 105. In one aspect, the packet switched network 103 may include base station 108, base station controller 124, Serving GPRS Support Node (SGSN) 126, PS core 128 and Combined GPRS Service Node (CGSN) 130. In another aspect, the circuit switched network 105 may include base station 108, base station controller 124, Mobile services Switching Centre (MSC), Visitor location register (VLR) 132, CS core 134 and Gateway Mobile Switching Centre (GMSC) 136.

The E-UTRAN 104 may include an evolved Node B (eNB) 106 and connection to other networks, such as packet and circuit switched networks may be facilitated through base station 108. The eNB 106 may provide user and control plane protocol terminations toward the UE 102. The eNB 106 may be connected to other eNBs 108 via an X2 interface (i.e., a backhaul). The eNB 106 may also be referred to as a base station, a base transceiver station, a radio base station, a radio transceiver, a transceiver function, a basic service set (BSS), an extended service set (ESS), or some other suitable terminology. The eNB 106 may provide an access point to the EPC 110 for UE 102. UE 102 may comprise, for example, a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or another device. The UE 102 may be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, and/or by some other suitable terminology.

The eNB 106 may be connected by an 51 interface to the EPC 110. The EPC 110 may include one or more Mobility Management Entities (MMEs) 112 and/or 114, a Serving Gateway 116, and a Packet Data Network (PDN) Gateway 118. MME 112 may comprise a control node that processes the signaling between UE 102 and EPC 110. Typically, MME 112 provides bearer and connection management. User IP packets may be transferred through the Serving Gateway 116, which may be connected to PDN Gateway 118. PDN Gateway 118 may provide IP address allocation for UE 102, as well as other functions. The PDN Gateway 118 may be connected to the Operator's IP Services 122. The Operator's IP Services 122 can include the Internet, an Intranet, an IP Multimedia Subsystem (IMS), and a PS Streaming Service (PSS).

In an aspect of the disclosure, the wireless system 100 may be configured and/or adapted to facilitate circuit switched fallback (CSFB). As used herein, CSFB may refer to establishing a signaling channel between a circuit switched MSC 132 and the LTE core network 101 to allow for services, such as voice calls, short message service (SMS), etc. In one example, when a UE 102 is moved from an LTE network 101 to a 3GPP network, such as a CS based network 103 (UTRAN), a packet switched (PS) network 103, etc., the UE may perform one or more registration procedures prior to communicating user data over the 3GPP network. If the transition from LTE network 101 to a CS based network 105 results from a CS call origination using a CSFB procedure, the registration procedures may add significant additional delays to the overall call setup delay. In one aspect, delays resulting from registration maybe related to processes for obtaining authentication during registration procedures. Registration procedures may be unavoidable and may be needed to enable proper operation of a network. However, certain embodiments perform registration procedures and call setup procedures contemporaneously.

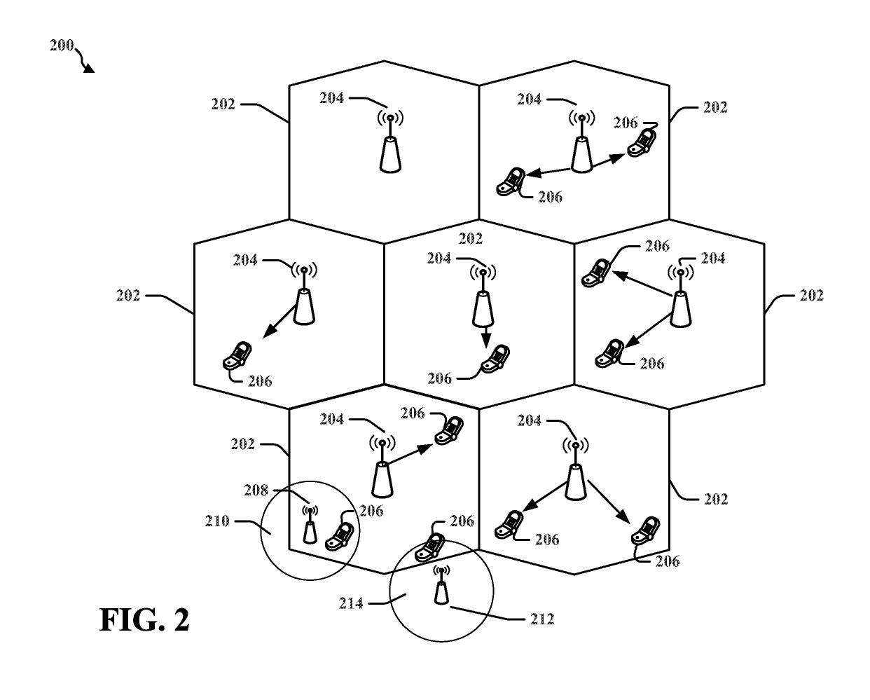

FIG. 2 is a diagram illustrating an access network 200 in an LTE network architecture, in accordance with aspects of the disclosure. In one example, the access network 200 is divided into a number of cellular regions (cells) 202. One or more lower power class eNBs 208, 212 may have cellular regions 210, 214, respectively, that overlap with one or more of the cells 202. The lower power class eNBs 208, 212 may be femto cells (e.g., home eNBs (HeNBs)), pico cells, or micro cells. A higher power class or macro eNB 204 is assigned to a cell 202 and is configured to provide an access point to the EPC 210 for all the UEs 206 in the cell 202. There is no centralized controller in this example of an access network 200, but a centralized controller may be used in some configurations. The eNB 204 may be responsible for all radio related functions including radio bearer control, admission control, mobility control, scheduling, security, and connectivity to the serving gateway 216 (see FIG. 1).

In accordance with certain aspects of the disclosure, modulation and multiple access schemes employed by the access network 200 may vary depending on the particular telecommunications standard being deployed. In LTE applications, OFDM may used on the DL and SC-FDMA may used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by 3GPP2 as part of the CDMA2000 family of standards and employs CDMA to provide broadband Internet access to mobile stations. These concepts may also be extended to UTRA employing W-CDMA and other variants of CDMA, such as TD-SCDMA; GSM employing TDMA; and E-UTRA, UMB, IEEE 802.11 (Wi-Fi), IEEE 802.16 (WiMAX), IEEE 802.20, and Flash-OFDM employing OFDMA. The choice of wireless communication standard and the multiple access technology employed typically depends on the specific application and overall design constraints imposed on the system.

In some embodiments, eNB 204 may have multiple antennas supporting MIMO technology. MIMO technology enables eNB 204 to exploit the spatial domain to support spatial multiplexing, beamforming, and transmit diversity.

Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream and then transmitting each spatially precoded stream through a different transmit antenna on the downlink. The spatially precoded data streams arrive at the UE(s) 206 with different spatial signatures, which enables each of the UE(s) 226 to recover the one or more data streams destined for that UE 206. On the uplink, each UE 206 transmits a spatially precoded data stream, which enables the eNB 204 to identify the source of each spatially precoded data stream.

Spatial multiplexing may generally be used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

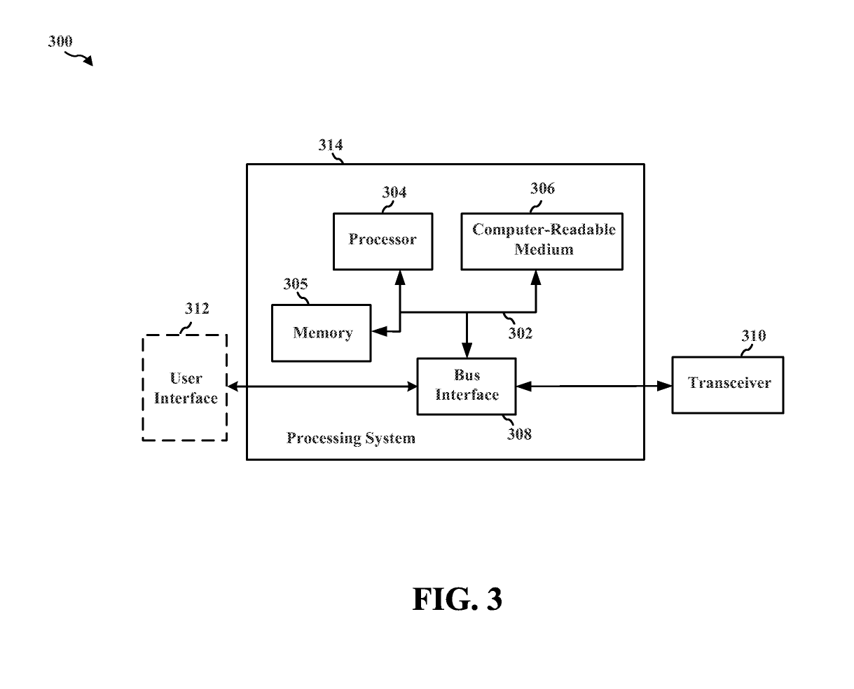

FIG. 3 is a diagram illustrating a simplified example of an implementation for an apparatus 300 employing a processing system 314 and a memory 305, in accordance with aspects of the disclosure. In one example, the processing system 314 may be implemented with a bus architecture, represented by bus 302. The bus 302 may include any number of interconnecting buses and bridges depending on the specific application of the processing system 314 and the overall design constraints. The bus 302 links together various circuits including one or more processors, represented generally by the processor 304, and computer-readable media, represented generally by the computer-readable medium 306. The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium. Depending on the nature of the apparatus 300, a user interface 312 (e.g., keypad, touchpad, monitor, display, speaker, microphone, joystick) may also be provided to interface with a user.

The processor 304 may be configured to manage bus 302 and to perform general processing, including the execution of software stored on the computer-readable medium 306. The software, when executed by the processor 304, causes the processing system 314 to perform the various functions described herein for any particular apparatus. The computer-readable medium 306 may also be utilized for storing data that is manipulated by the processor 304 when executing software.

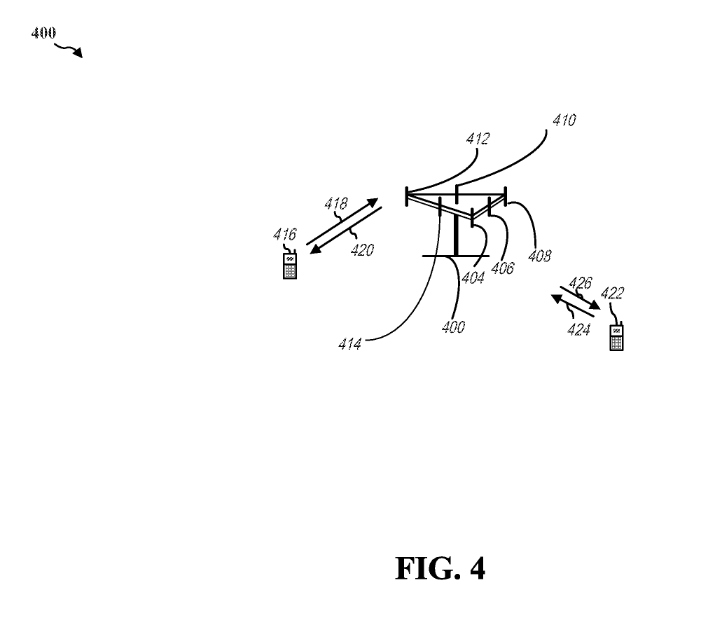

FIG. 4 is a diagram illustrating an embodiment of a multiple access wireless communication system, in accordance with certain aspects of the disclosure. An access point (AP) 400 includes multiple antenna groups, for example, one including 404 and 406, another including 408 and 410, and an additional including 412 and 414. In FIG. 4, only two antennas are shown for each antenna group; however, more or fewer antennas may be utilized for each antenna group. Access terminal (AT) 416 may be in communication with antennas 412 and 414, where antennas 412 and 414 transmit information to access terminal 416 over forward link or downlink (DL) 420 and receive information from access terminal 416 over reverse link or uplink (UL) 418. Access terminal 422 is in communication with antennas 406 and 408, where antennas 406 and 408 transmit information to access terminal 422 over forward link or downlink (DL) 426 and receive information from access terminal 422 over reverse link or uplink (UL) 424.

In an aspect of the disclosure, in a frequency division duplexing (FDD) system, communication links 418, 420, 424 and 426 may use different frequency for communication. For example, forward link or downlink (DL) 420 may use a different frequency then that utilized by reverse link or uplink (UL) 418.

In an aspect of the disclosure, each group of antennas and/or the area in which they are designed to communicate may be referred to as a sector of the access point. In an example, each antenna group may be designed to communicate to access terminals in a sector of the areas covered by access point 400.

When communicating over forward links or downlinks (DLs) 420, 426, the transmitting antennas of access point 400 may utilize beamforming to improve a signal-to-noise ratio of the forward links or downlinks 420, 426 for the different access terminals 416 and 424, respectively. Also, an access point utilizing beamforming to transmit to access terminals scattered randomly through its coverage may cause less interference to access terminals in neighboring cells than an access point transmitting through a single antenna to all its access terminals.

AP 400 may comprise a Node B (NB) or eNB. AT 416 may comprise a UE, or other wireless communication device or terminal Moreover, AP 400 may comprise a macrocell access point, femtocell access point, picocell access point, or the like.

In certain embodiments, one or more segments and/or one or more extension carriers may be linked to a regular carrier resulting in a composite bandwidth over which the UE may transmit information to, and/or receive information from, the eNB.

In the description that follows, various aspects of an access network will be described with reference to a MIMO system supporting OFDM on downlink (DL) and SC-FDMA on uplink (UL). OFDM is a spread-spectrum technique that modulates data over a number of subcarriers within an OFDM symbol. The subcarriers are spaced apart at precise frequencies. The spacing provides “orthogonality” that enables a receiver to recover data from subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PARR).

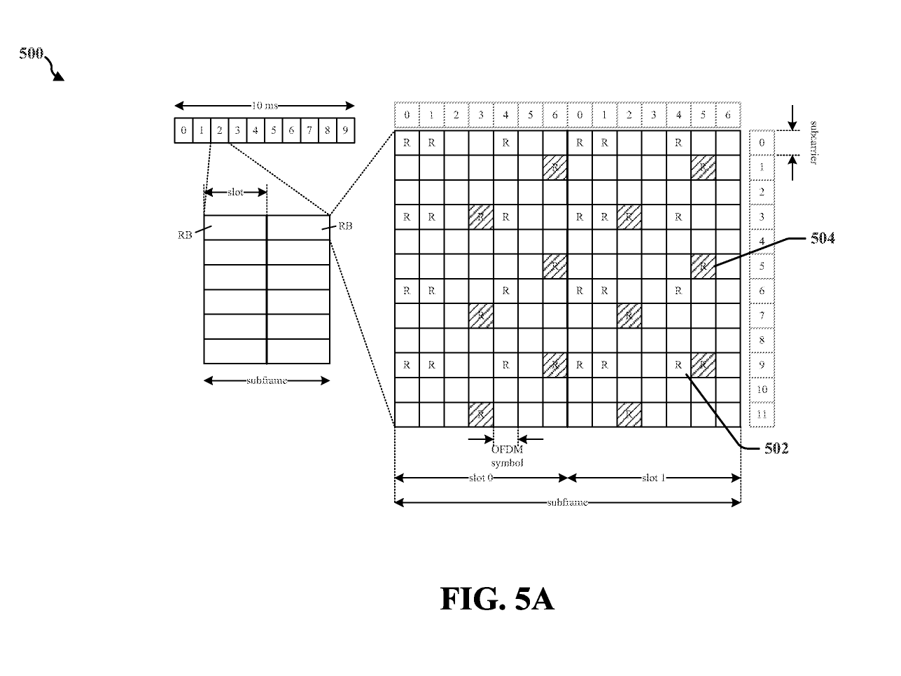

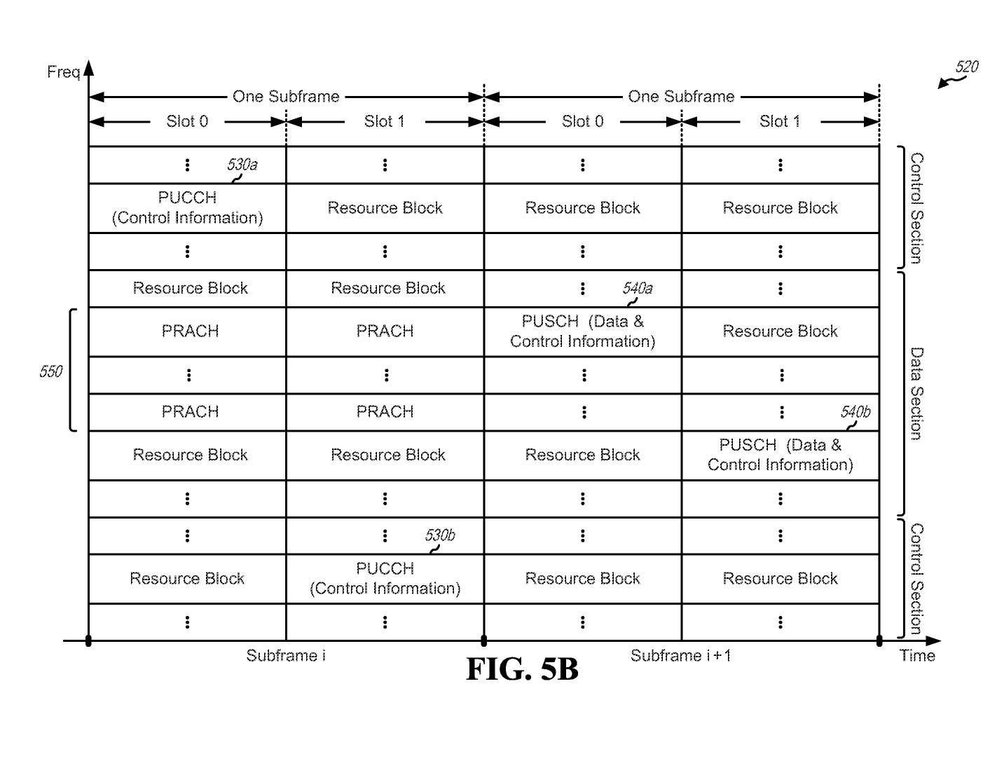

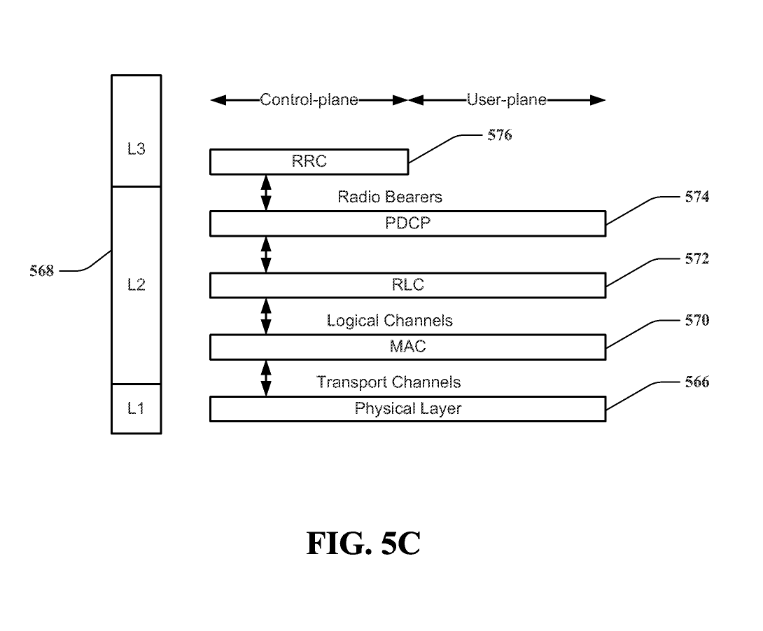

In accordance with aspects of the disclosure, various frame structures may be utilized to support DL and UL transmissions. An example of a DL frame structure will now be presented with reference to FIG. 5A. However, as those skilled in the art will readily appreciate, the frame structure for any particular application may be different depending on any number of factors. In this example, a frame (10 ms) is divided into 10 equally sized sub-frames, and each sub-frame includes two consecutive time slots.

In an implementation, a resource grid may be utilized to represent two time slots, each time slot including a Resource Block (RB). The resource grid is divided into multiple Resource Elements (REs). In LTE, a Resource Block (RB) may include 12 consecutive subcarriers in the frequency domain and, for a normal cyclic prefix in each OFDM symbol, 7 consecutive OFDM symbols in the time domain, or 84 Resource Elements (REs). Some of the REs, as indicated as R 502 and 504, may include DL Reference Signals (DL-RS). The DL-RS include Cell-specific RS (CRS) (which may be referred to as common RS) 502 and UE-specific RS (UE-RS) 504. UE-RS 504 may be transmitted only on the RBs upon which a corresponding Physical Downlink Shared CHannel (PDSCH) is mapped. The number of bits carried by each RE may depend on the modulation scheme. As such, the more RBs that a UE receives and the higher the modulation scheme, the higher the data rate for the UE.

Referring to FIG. 5B, an example of a UL frame structure 520 is provided in an embodiment of a format for the UL in LTE. Available Resource Blocks (RBs) for the UL may be partitioned into a data section and a control section. The control section may be formed at the two edges of the system bandwidth and may have a configurable size. The RBs in the control section may be assigned to UEs for transmission of control information. The data section may include RBs not included in the control section. The design in FIG. 5B results in the data section including contiguous subcarriers, which may allow a single UE to be assigned one or more of the contiguous subcarriers in the data section.

In one example, a UE may be assigned Resource Blocks (RBs) 530a, 530b in a control section to transmit control information to an eNB. The UE may be assigned RBs 540a, 540b in a data section to transmit data to the eNB. The UE may transmit control information in a Physical Uplink Control CHannel (PUCCH) on the assigned RBs in the control section. The UE may transmit only data or both data and control information in a Physical Uplink Shared CHannel (PUSCH) on the assigned RBs in the data section. A UL transmission may span both slots of a subframe and may hop across frequency, in a manner as shown in FIG. 5B.

Referring again to FIG. 5B, a set of RBs may be utilized to perform initial system access and achieve UL synchronization in a Physical Random Access CHannel (PRACH) 550. The PRACH 550 may be configured to carry a random sequence and cannot carry any UL data/signaling. Each random access preamble may occupy bandwidth corresponding to six consecutive RBs. The starting frequency may be specified by the network. That is, the transmission of the random access preamble may be restricted to certain time and frequency resources. There is typically no frequency hopping for the PRACH. The PRACH attempt is carried in a single subframe (1 ms), and a UE may make only a single PRACH attempt per frame (10 ms).

The radio protocol architecture may take on various forms depending on the particular application. An example for an LTE system will now be presented with reference to FIG. 5C. In an aspect of the disclosure, FIG. 5C is a conceptual diagram illustrating an example of the radio protocol architecture for the user and control planes.

In FIG. 5C, the radio protocol architecture for the UE and the eNB is shown with three layers: Layer 1 (L1), Layer 2 (L2), and Layer 3 (L3). L1 is the lowest layer and implements various physical layer signal processing functions. L1 is referred to herein as a physical layer 566. L2 568 is above the physical layer (L1) 566 and is responsible for the link between the UE and eNB over the physical layer (L1) 566.

In the user plane, the L2 layer 568 includes a media access control (MAC) sublayer 570, a radio link control (RLC) sublayer 572, and a Packet Data Convergence Protocol (PDCP) 574 sublayer, which are terminated at the eNB on the network side. Although not shown, the UE may have several upper layers above the L2 layer 568 including a network layer (e.g., IP layer) that is terminated at the PDN gateway 318 (e.g., see FIG. 3A) on the network side, and an application layer that is terminated at the other end of the connection (e.g., far end UE, server, etc.).

The PDCP sublayer 574 provides multiplexing between different radio bearers and logical channels. The PDCP sublayer 574 may provide header compression for upper layer data packets to reduce radio transmission overhead, security by ciphering the data packets, and/or handover support for UEs between eNBs. The RLC sublayer 572 provides segmentation and reassembly of upper layer data packets, retransmission of lost data packets, and/or reordering of data packets to compensate for out-of-order reception due to Hybrid Automatic Repeat Request (HARQ). The MAC sublayer 570 provides multiplexing between logical and transport channels, and the MAC sublayer 570 is responsible for allocating the various radio resources (e.g., RBs) in one cell among the UEs. The MAC sublayer 570 is responsible for HARQ operations.

In the control plane, the radio protocol architecture for the UE and eNB is substantially the same for the physical layer 566 and the L2 layer 568 with the exception that there is no header compression function for the control plane. The control plane includes a Radio Resource Control (RRC) sublayer 576 in Layer 3. The RRC sublayer 576 is responsible for obtaining radio resources (i.e., radio bearers) and for configuring the lower layers utilizing RRC signaling between the eNB and the UE.

Certain embodiments provide PDN recovery failure handling procedures, including methods for determining the cause of the reconnection failure and selectively enabling reconnect when the reconnection failure is caused by reasons other than network failure. For instance, problems may result from USIM and/or CSIM refresh that may cause PDN failure handling to be initiated that can cause detach from an LTE RAN and block access to the RAN for a predefined period of time. In one example, a predefined period of time (such as T3402) may be set at 12 minutes. Accordingly, the UE may be prevented from connection to an IMS PDN for 12 minutes or more after PDN failure handling is initiated, even when no network problem exists. In some embodiments, PDN recovery failure handling procedures accommodate internal connection failures generated due to interactions between the UE and the network. In some embodiments, PDN recovery failure handling procedures accommodate internal connection failures arising from timers configured by a carrier for carrier-specific applications, but which impact internal operations due to prolonged blocking of access to certain RANs because of the timer settings.

In some embodiments, a UE may perform a recovery sequence that includes a detach procedure to disconnect from an IMS PDN, followed by an immediate attach procedure upon receiving a message or detecting a connection failure. In one example, the recovery sequence may be performed when the UE receives a PDN CONNECTIVITY REJECT message after a UE-initiated IMS PDN connection attempt fails on LTE Radio Access Technology (RAT) of a serving Public Land Mobile Network (PLMN). If the recovery sequence does not result in reconnection, the UE may determine the cause of the failure of the recovery sequence and, based on the nature of the cause, may attempt another network connection after a delay that is less than the backoff period defined by the network operator. In some embodiments, access to an LTE RAN on a different PLMN and access to non-LTE RANs on the serving PLMN is not be blocked.

The UE may perform an LTE RAN detach procedure and may then block attempts to attach to the LTE RAN of the serving PLMN for the predefined time period (e.g., 12 minutes) if the UE initiated IMS PDN connection attempt fails on an LTE RAT of the serving PLMN due to reasons other than the explicit receipt of PDN CONNECTIVITY REJECT message, for example. In some embodiments, LTE RAN on other PLMNs and non-LTE RANs on the serving PLMN may not be blocked.

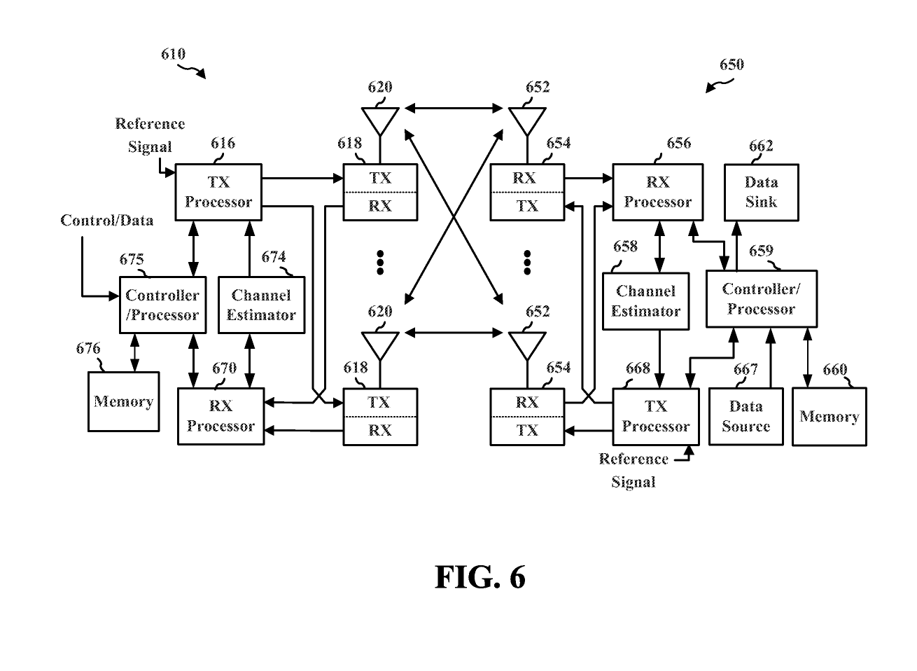

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

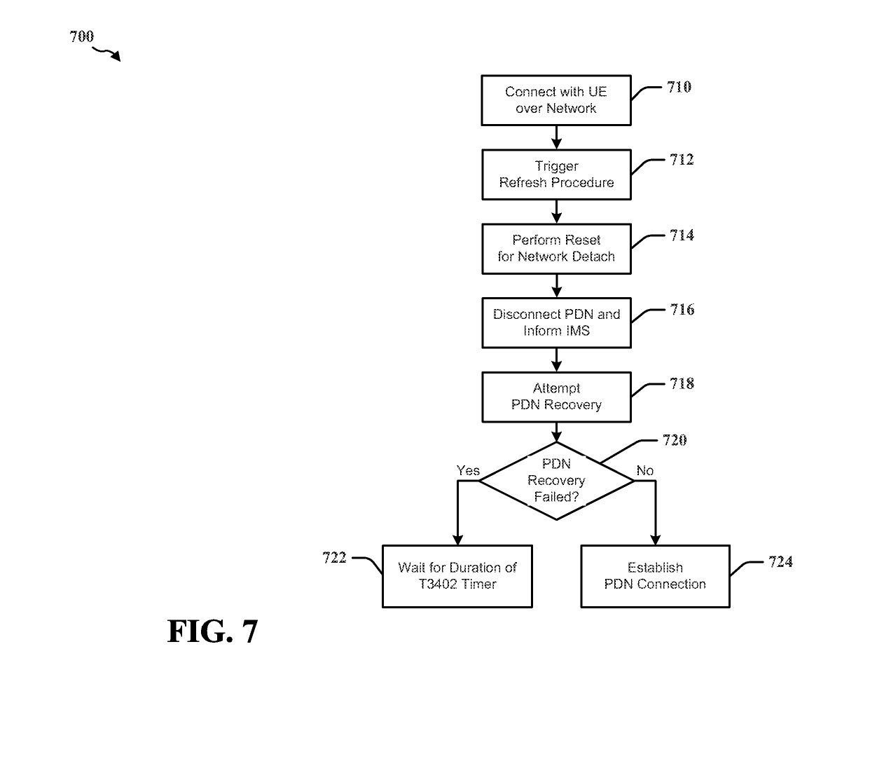

FIG. 7 shows a diagram illustrating a process flow to reduce recovery failure delay in a communication network, in accordance with certain aspects of the disclosure. The process may be performed, at least in part, by UE 610.

At 710, UE 610 is configured to attach to LTE or eHRPD (evolved High Rate Packet Data) network, and PDNs are connected. In one example, an IMS client on UE 610 is configured to activate Packet Data Protocol (PDP) context for an IMS PDN bearer. PDP Context includes setup of one or more of the following parameters: PDP Type, PDP address type, Quality of Service (QoS) profile, and Authentication type. In another example, the IMS client is configured to perform IMS registration with IMS core network over the PDN bearer.

At 712, UE 610 may cause a USIM or CSIM refresh procedure to be triggered by the IMS core network. In an implementation, a data connection is established with the network to perform an update procedure to modules of USIM or CSIM.

At 714, following USIM or CSIM refresh procedure, the UE 610 is configured to perform a soft reset to update parameters updated during the procedure above and for the device to start working with the new parameters. In an implementation, this soft reset may trigger a detach from LTE network followed by an immediate attach. The UE may start detach from LTE or eHRPD network.

At 716, the detach from LTE or eHRPD network causes PDN to be disconnected and an indication is given to the IMS layer or the IMS client.

At 718, UE 610 is configured to attempt PDN recovery, and if the recovery attempt fails at 720, then at 722, UE 610 detaches from LTE network for T3402 (e.g., 12 minutes), and if the failure was on eHRPD, UE 610 avoids establishing the IMS connection for T3402. Otherwise, if the recovery attempt does not fail at 720, then at 724, the UE attempts to establish connection with the network.

In an implementation, at 718, UE 610 is configured to immediately attempt PDN recovery, but UE 610 is in detach followed by attach state triggered by the USIM or CSIM refresh procedure, and PDN recovery fails because UE 610 is not ready. Due to the failure, UE 610 is configured to detach from LTE or from that PLMN and camp on another PLMN for a period of time defined by a carrier specific avoidance timer. If the failure occurred while camped on eHRPD, IMS registration or establishing IMS connection may be avoided on eHRPD for duration of T3402 timer. Since there may be only one PLMN for LTE, UE 610 may not be on LTE for a period of T3402 timer.

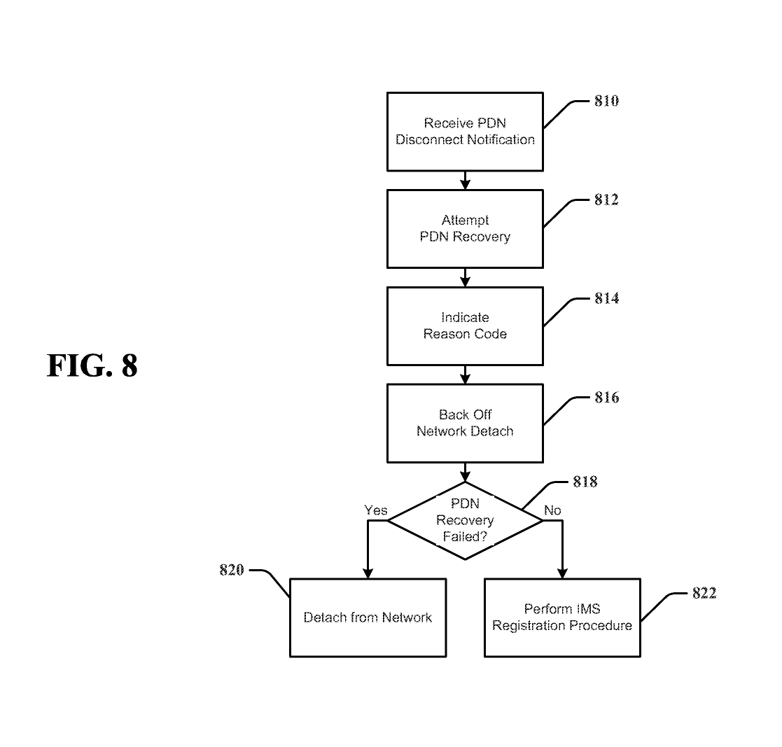

FIG. 8 shows a diagram illustrating a process flow to reduce recovery failure delay in a communication network for block 6 of FIG. 6, in accordance with certain aspects of the disclosure.

At 810, an IMS client of UE 610 receives a PDN disconnect notification.

At 812, IMS client or IMS Framework stack attempts PDN recovery by attempting to establish a PDN connection by sending a PDP activation request to a data services module of UE 610. The UE 610 may initiate an attempt to reconnect to the IMS PDN by performing a PDN detach, and subsequently performing a PDN attach immediately after detaching from the IMS and/or the PDN. The UE 610 may receive notification of a failure to reconnect to the PDN and may determine a reason for the failure to reconnect. The reason may be expressed in a reason code. The reason code may be generated during the attempt to reconnect to the PDN network.

In some embodiments, UE 610 attempts reconnection to the PDN by performing a packet data network detach, and subsequently performing a PDN immediately after detaching from the PDN.

At 814, the data services subsystem in UE 610 indicates to the IMS client a reason code NO SERV, which indicates to the IMS client that the failure to establish the PDN connection is due to an internal reason and not related to network.

At 816, instead of the IMS client applying the logic of detaching from this LTE

PLMN or network and blocking it for T3402 (12 minutes), the IMS client backs off for a configurable period of time, for example, within a range of 30 to 60 seconds, and retires the PDN recovery.

In some embodiments, UE 610 requests a connection to the PDN after a backoff time selected based on the reason for the failure to reconnect. The selected backoff time may comprise one or more minimum backoff times defined by a network operator for activating the PDN after reconnect failures. The minimum backoff time defined by the network operator may be measured in seconds and may be 12 seconds or more. The selected backoff time may be the minimum backoff time defined by the network operator when the failure to reconnect occurs as a result of a failure attributable to the PDN, rather than the UE 610. The selected backoff time may comprise a locally configured minimum backoff time that is less than the minimum backoff time defined by the network operator. In one example, the locally configured minimum backoff time is less than 1 minute. In some embodiments, the duration of the minimum backoff time is configurable by the network operator and exceeds one or two minutes and can exceed 12 or 15 minutes. In some embodiments, the locally configured minimum backoff time is less than 1 minute. In some embodiments, the locally configured minimum backoff time may be set to no delay (no seconds), although at least some nominal delay is typically set. The backoff time may comprise the locally configured minimum backoff time when the notification of disconnection is received after performing a procedure that includes detaching from the PDN. The procedure may comprise a USIM refresh procedure or a CDMA SIM refresh procedure. The notification of disconnection may be received from the packet data network.

At 820, upon failure at 818 after the back off period, UE 610 is configured to proceed to detach from LTE or PLMN, and the UE blocks LTE or PLMN for T3402. If UE 610 succeeds at 818, then at 822, the IMS client activates the PDP context and performs IMS registration procedure with the network.

In an aspect of the disclosure, with the techniques described herein, UE 610 is configured to circumvent the USIM or CSIM refresh procedure in the network, and UE 610 is able to camp on the system with high data rate. UE 610 may also be configured to receive IMS services on the network, such as SMS/IMS, VoIP, Video Telephony, and/or one or more other IMS services.

In some embodiments, UE 610 performs a reset. The reset may trigger a detach from the PDN followed by an immediate attach to the PDN. In some embodiments the PDN comprises an LTE RAN. In some embodiments the PDN comprises an eHRPD network.

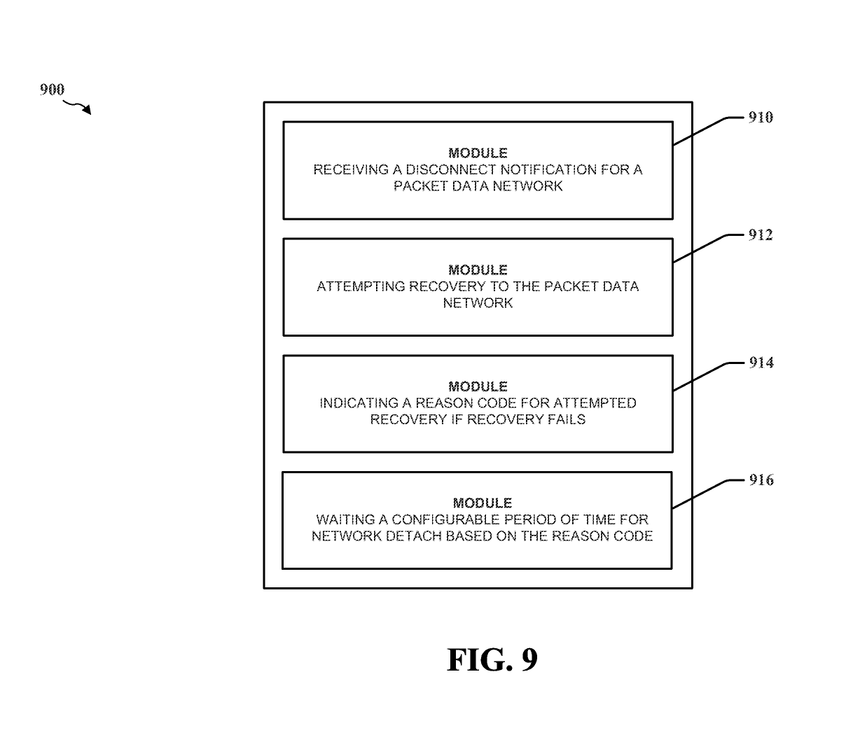

FIG. 9 is a diagram 900 illustrating an embodiment of functionality of an apparatus (e.g., apparatus 300 of FIG. 3) configured to facilitate wireless communication, in accordance with aspects of the disclosure. The apparatus includes a module 910 configured for receiving a disconnect notification for a packet data network. The apparatus includes a module 912 configured for attempting recovery to the packet data network. The apparatus includes a module 914 configured for indicating a reason code for attempted recovery if recovery fails. The apparatus includes a module 916 configured for waiting a configurable period of time for network detach based on the reason code, which is at least less than a predefined period of time. The apparatus may include additional modules that perform each of the steps in the aforementioned flow charts. As such, each step in the aforementioned flow charts may be performed by a module and the apparatus may include one or more of those modules.

The aforementioned modules 910, 912, 914, and 916 may be one or more of the aforementioned modules of the apparatus 300 and/or the processing system 314 of the apparatus 300 configured to perform the functions recited by the aforementioned means. The processing system 314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned modules.

Referring to FIG. 3, in a configuration, the apparatus 300 for wireless communication comprises the processing system 314 configured to provide a means for receiving a disconnect notification for a packet data network, a means for attempting recovery to the packet data network, a means for indicating a reason code for attempted recovery if recovery fails, and a means for waiting a configurable period of time for network detach based on the reason code, which is at least less than a predefined period of time. The processing system 314 may be a component of the UE 650 (see FIG. 6) and may include the memory 660 and/or at least one of the TX processor 668, the RX processor 656, and the controller/processor 659.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which may be a wired terminal or a wireless terminal A terminal may also be called a system, device, subscriber unit, subscriber station, mobile station, mobile, mobile device, remote station, remote terminal, access terminal, user terminal, terminal, communication device, user agent, user device, or UE. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

It should be understood and appreciated that various aspects or features are presented in terms of systems that may include a number of devices, components, modules, and the like. It should also be understood and appreciated that the various systems may include additional devices, components, modules, etc. and/or may not include all of the devices, components, modules etc. discussed in connection with the figures. A combination of these approaches may also be used.

The various illustrative logic, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor may read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that may be accessed by a computer. By way of example, and not limitation, such computer-readable media may include non-volatile storage comprising RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method for wireless communication, comprising:
receiving a notification of disconnection from a packet data network;
initiating an attempt to reconnect to the packet data network;
responsive to a failure to reconnect to the packet data network, determining a reason for the failure to reconnect; and
requesting a connection to the packet data network after a backoff time selected based on the reason for the failure to reconnect,
wherein the selected backoff time comprises one of a minimum backoff time defined by a network operator for activating the packet data network after reconnect failures, and a locally configured minimum backoff time that is less than the minimum backoff time defined by the network operator.

2. The method of claim 1, wherein reconnection to the packet data network is attempted by performing a packet data network detach, and subsequently performing a packet data network attach immediately after detaching from the packet data network.

3. The method of claim 2, wherein the selected backoff time comprises the locally configured minimum backoff time when the notification of disconnection is received after performing a procedure that includes detaching from the packet data network.

4. The method of claim 3, wherein the procedure comprises a universal subscriber identity module (USIM) refresh procedure or a code division multiple access (CDMA) subscriber identity module (CSIM) refresh procedure, and wherein the notification of disconnection is received from the packet data network.

5. The method of claim 3, wherein the selected backoff time comprises the minimum backoff time defined by the network operator when the failure to reconnect occurs as a result of a failure of the packet data network.

6. The method of claim 1, wherein determining the reason for the failure to reconnect includes identifying a reason code generated during the attempt to reconnect to the packet data network.

7. The method of claim 1, further comprising performing a reset, wherein the reset triggers a detach from the packet data network followed by an immediate attach to the packet data network.

8. The method of claim 1, wherein the packet data network comprises a Long Term Evolution (LTE) network or a evolved High Rate Packet Data (eHRPD) network.

9. The method of claim 1, wherein the duration of the minimum backoff time is configurable by the network operator and exceeds two minutes, and wherein the locally configured minimum backoff time is less than 1 minute.

10. An apparatus for wireless communication, comprising:
a processing system configured to:
receive a notification of disconnection from a packet data network;
initiate an attempt to reconnect to the packet data network;
responsive to a failure to reconnect to the packet data network, determine a reason for the failure to reconnect; and
request a connection to the packet data network after a backoff time selected based on the reason for the failure to reconnect,
wherein the selected backoff time comprises one of a minimum backoff time defined by a network operator for activating the packet data network after reconnect failures, and a locally configured minimum backoff time that is less than the minimum backoff time defined by the network operator.

11. The apparatus of claim 10, wherein the processing system is further configured to attempt the reconnection to the packet data network by performing a packet data network detach, and subsequently performing a packet data network attach immediately after detaching from the packet data network.

12. The apparatus of claim 11, wherein the selected backoff time comprises the locally configured minimum backoff time when the notification of disconnection is received after performing a procedure that includes detaching from the packet data network.

13. The apparatus of claim 12, wherein the procedure comprises a universal subscriber identity module (USIM) refresh procedure or a code division multiple access (CDMA) subscriber identity module (CSIM) refresh procedure, and wherein the notification of disconnection is received from the packet data network.

14. The apparatus of claim 12, wherein the selected backoff time comprises the minimum backoff time defined by the network operator when the failure to reconnect occurs as a result of a failure of the packet data network.

15. The apparatus of claim 10, wherein the processing system is configured to determine the reason for the failure to reconnect by identifying a reason code generated during the attempt to reconnect to the packet data network.

16. The apparatus of claim 10, wherein the processing system is further configured perform a reset, wherein the reset triggers a detach from the packet data network followed by an immediate attach to the packet data network.

17. The apparatus of claim 10, wherein the packet data network comprises a Long Term Evolution (LTE) network or a evolved High Rate Packet Data (eHRPD) network.

18. The apparatus of claim 10, wherein the duration of the minimum backoff time is configurable by the network operator and exceeds two minutes, and wherein the locally configured minimum backoff time is less than 1 minute.

19. An apparatus for wireless communication, comprising:
means for receiving a notification of disconnection from a packet data network;
means for initiating an attempt to reconnect to the packet data network;
means for responsive to a failure to reconnect to the packet data network, determining a reason for the failure to reconnect; and
means for requesting a connection to the packet data network after a backoff time selected based on the reason for the failure to reconnect,
wherein the selected backoff time comprises one of a minimum backoff time defined by a network operator for activating the packet data network after reconnect failures, and a locally configured minimum backoff time that is less than the minimum backoff time defined by the network operator.

20. The apparatus of claim 19, wherein the means for initiating the attempt to reconnect to the packet data network is configured to perform a packet data network detach, and to subsequently perform a packet data network attach immediately after detaching from the packet data network.

21. The apparatus of claim 20, wherein the selected backoff time comprises the locally configured minimum backoff time when the notification of disconnection is received after performing a procedure that includes detaching from the packet data network.

22. The apparatus of claim 21, wherein the procedure comprises a universal subscriber identity module (USIM) refresh procedure or a code division multiple access (CDMA) subscriber identity module (CSIM) refresh procedure, and wherein the notification of disconnection is received from the packet data network.

23. The apparatus of claim 21, wherein the selected backoff time comprises the minimum backoff time defined by the network operator when the failure to reconnect occurs as a result of a failure of the packet data network.

24. The apparatus of claim 19, wherein the means for determining the reason for the failure to reconnect identifies a reason code generated during the attempt to reconnect to the packet data network.

25. The apparatus of claim 19, further comprising means for performing a reset, wherein the reset triggers a detach from the packet data network followed by an immediate attach to the packet data network.

26. The apparatus of claim 19, wherein the packet data network comprises a Long Term Evolution (LTE) network or a evolved High Rate Packet Data (eHRPD) network.

27. The apparatus of claim 19, wherein the duration of the minimum backoff time is configurable by the network operator and exceeds two minutes, and wherein the locally configured minimum backoff time is less than 1 minute.

28. A computer program product, comprising:
a computer-readable medium comprising code for:
receiving a notification of disconnection from a packet data network;
initiating an attempt to reconnect to the packet data network;
responsive to a failure to reconnect to the packet data network, determining a reason for the failure to reconnect; and
requesting a connection to the packet data network after a backoff time selected based on the reason for the failure to reconnect,
wherein the selected backoff time comprises one of a minimum backoff time defined by a network operator for activating the packet data network after reconnect failures, and a locally configured minimum backoff time that is less than the minimum backoff time defined by the network operator.

29. The computer program product of claim 28, wherein reconnection to the packet data network is attempted by performing a packet data network detach, and subsequently performing a packet data network attach immediately after detaching from the packet data network.

30. The computer program product of claim 29, wherein the selected backoff time comprises the locally configured minimum backoff time when the notification of disconnection is received after performing a procedure that includes detaching from the packet data network.

31. The computer program product of claim 30, wherein the procedure comprises a universal subscriber identity module (USIM) refresh procedure or a code division multiple access (CDMA) subscriber identity module (CSIM) refresh procedure, and wherein the notification of disconnection is received from the packet data network.

32. The computer program product of claim 30, wherein the selected backoff time comprises the minimum backoff time defined by the network operator when the failure to reconnect occurs as a result of a failure of the packet data network.

33. The computer program product of claim 28, wherein determining the reason for the failure to reconnect includes identifying a reason code generated during the attempt to reconnect to the packet data network.

34. The computer program product of claim 28, wherein the computer-readable medium comprises code for performing a reset, wherein the reset triggers a detach from the packet data network followed by an immediate attach to the packet data network.

35. The computer program product of claim 28, wherein the packet data network comprises a Long Term Evolution (LTE) network or a evolved High Rate Packet Data (eHRPD) network.

36. The computer program product of claim 28, wherein the duration of the minimum backoff time is configurable by the network operator and exceeds two minutes, and wherein the locally configured minimum backoff time is less than 1 minute.
